(19) United States
(12) Patent Application Publication
(10) Pub. No.: US 2009/0058958 A1
(43) Pub. Date: Mar. 5, 2009

(54) Environmental protection ink cartridge / toner cartridge automatic refill chip

(76) Inventor: Alex Kuo-Shen Wang, Las Vegas, NV (US)

Correspondence Address: PRO-TECHTOR INTERNATIONAL, 20775 Norada Court, Saratoga, CA, 95070-3018, US

(21) Appl. No.: 11/895,790

(22) Filed: Aug. 27, 2007

(51) Int. Cl. B41J 2/175

(52) U.S. Cl. 347/86

(57) ABSTRACT

The present invention provides an environmental protection ink cartridge/toner cartridge auto repeated usage chip, wherein the control chip is structured to embody a CPU control circuit, a data bus and a plurality of memory chips. The control chip is installed on an ink cartridge, and transmits signals to a printer by means of the data bus. The memory chips include an ink cartridge model number data memory, an ink cartridge monitoring ink refill point data memory, and an ink cartridge automatic refill to full amount memory, which enable a restore amount starting point to be set for usage amount of the ink cartridge to serve as a monitoring point, and if the amount of ink becomes lower than the monitoring point, then an ink refill mechanism is activated, which fully refills the ink cartridge with ink again, thereby achieving effectiveness of environmental protection.

### BACKGROUND OF THE INVENTION

(a) Field of the Invention

The present invention provides functionality for repeated usage of a printer ink cartridge, thereby averting environmental problems caused by mass discarding of ink cartridges after usage.

(b) Description of the Prior Art

Referring to FIG. 1, which shows an ink cartridge 100 of a general inkjet printer having a sponge 200 packed within the ink cartridge 100, and wherewith capillarity of the sponge 200 is utilized to supply a steady and even quantity of ink to a nozzle of the printer. However, because of inability of the ink cartridge 100 to be reused, the ink cartridge 100 must be disposed of after the ink within is depleted. Even though a user can reluctantly re-inject ink into the ink cartridge 100, repeated injecting of ink will slowly cause deterioration of the sponge 200, and thus influence print quality of the ink cartridge 100, resulting in inability to reuse. As a consequence the Ink cartridges 100 are disposed of in considerable quantities, bringing about serious problems in environmental protection recovery.

### SUMMARY OF THE INVENTION

A primary objective of the present invention is to provide a control chip structured to embody a CPU control circuit, a data bus and a plurality of memory chips, wherewith the control chip can provide for repeated usage of the ink cartridge, wherein a restore amount starting point is set for usage amount of the ink cartridge to serve as a monitoring point, and if the amount of ink becomes lower than the monitoring point, then an ink refill mechanism is activated, which fully refills the ink cartridge with ink again.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cross-sectional view of a conventional ink cartridge.

FIG. 2 shows a cross-sectional view according to the present invention.

FIG. 3 shows a block diagram according to the present invention.

FIG. 4 shows an operating flow chart ( [symbol] ) according to the present invention.

FIG. 5 shows an operating flow chart ( [symbol] ) according to the present invention.

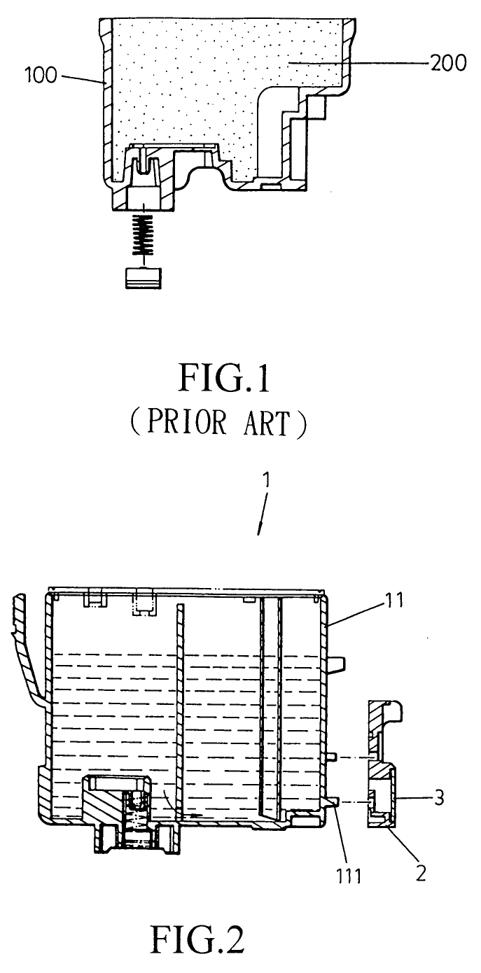

### DETAILED DESCRIPTION OF THE PREFERRED EMBODIMENTS

Referring to FIG. 2, which shows a chip socket 2 being removeably plugged onto a clip retainer 111 on one side of a plastic casing 11 of an ink cartridge 1 configured atop the chip socket 2.

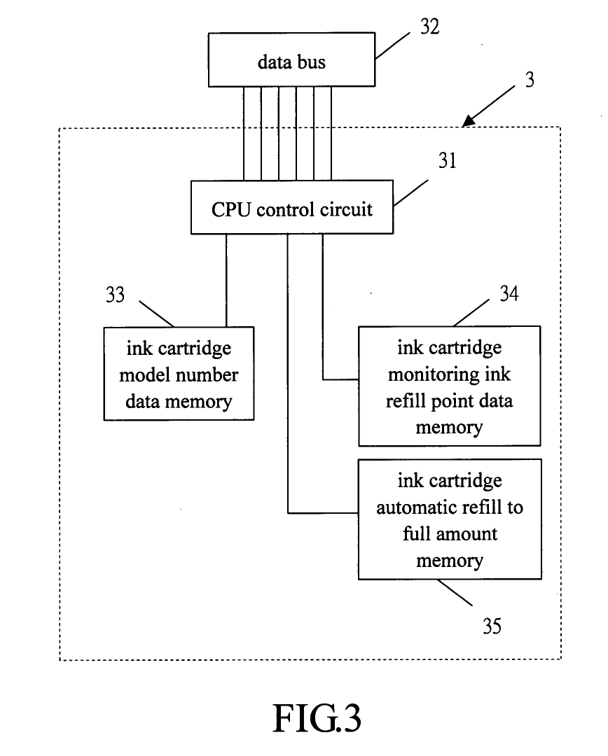

Referring to FIG. 3, the control chip 3 is structured to comprise a CPU control circuit 31, a data bus 32, an ink cartridge model number data memory 33, an ink cartridge monitoring ink refill point data memory 34 and an ink cartridge automatic refill to full amount memory 35 that resets the ink amount restore value after ink amount of the ink cartridge 1 has reached a return point and has been refilled. One end of the data bus 32 is connected to the CPU control circuit 31, and another end of the data bus 32 is adapted for connection to a printer, thereby realizing signal transmission between the printer and the control chip 3. Furthermore, the three memory chips 33, 34 and 35 are separately connected to the CPU control circuit 31.

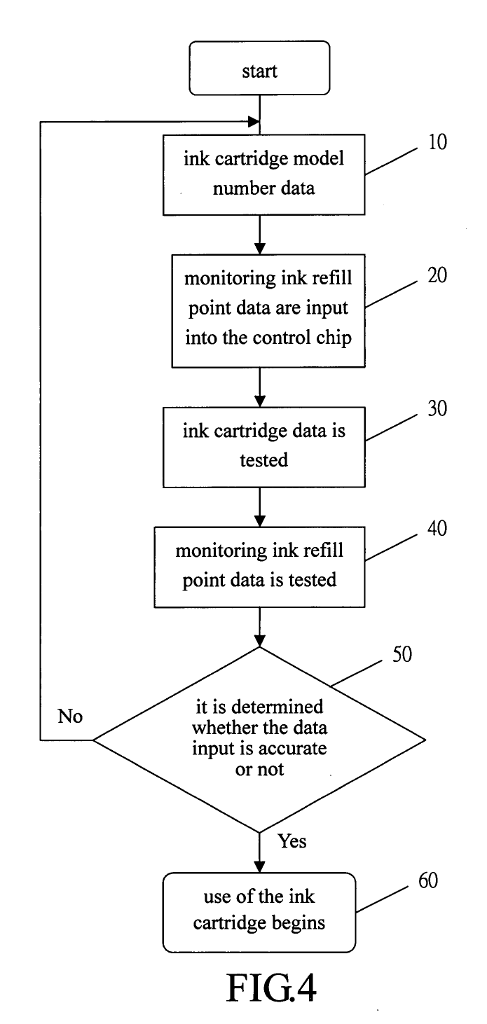

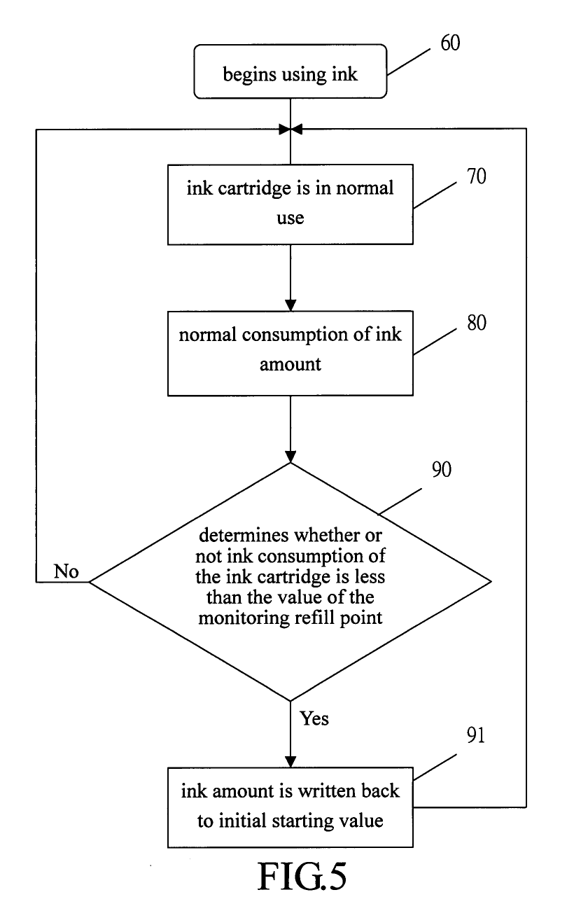

Referring to FIG. 4, prior to using a printer, in step 10, the ink cartridge model number data, and in step 20, the monitoring ink refill point data are input into the control chip 3 of the present invention, after which, in step 30, the ink cartridge data is tested, and in step 40, the monitoring ink refill point data is tested; then in step 50, it is determined whether the data input is accurate or not, and if not, then the process returns to step 10 to continue the input of the ink cartridge data; if the data input is accurate, then step 60 is implemented and use of the ink cartridge begins.

Referring to FIG. 5, first, in step 60, the control chip 3 of the present invention begins using ink, and in step 70, the ink cartridge is in normal use, after which, step 80 proceeds with normal consumption of ink amount, then step 90 determines whether or not ink consumption of the ink cartridge is less than the value of the monitoring refill point, if not, then the process returns to step 70 and continues with normal use of the ink cartridge, if yes, then step 91 is implemented whereby the ink amount is written back to initial starting value.

Description of the aforementioned flow charts, usage amount of the ink cartridge 1 is set to the restore amount starting point to serve as a monitoring point, and when the amount of ink is less than the monitoring point, then the ink refill mechanism is activated, which refills the ink cartridge 1. Such a method is applicable for use with any brand of ink cartridge, and various ink cartridge chips (containing toner cartridge chips).

In conclusion, the present invention realizes functionality for repeated usage of the ink cartridge, wherein, when the amount of ink in the ink cartridge 1 is close to being completely used, then the ink cartridge 1 is automatically refilled with ink, thereby averting pollution of global environment.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An environmental protection ink cartridge/toner cartridge with a control chip, comprising:
an ink cartridge having a plastic casing with a refillable ink reservoir, and a clip retainer on an exterior side thereof; and
a chip socket, fittingly adapted to removeably plug into said clip retainer, having a CPU control circuit;
a data bus, one end of which is connected to the CPU control circuit, and another end of which is adapted for connection to a printer;
a plurality of rewriteable memory chips, consisting of:
an ink cartridge model number data memory,
an ink cartridge monitoring ink refill point data memory, and
an ink cartridge automatic refill to full amount memory, which are each separately connected to the CPU control circuit, and separately provide functionality to monitor an ink amount within the ink cartridge, set an ink amount within the ink cartridge, set an ink amount return point of the ink cartridge and reset an ink amount restore value after the ink cartridge has reached the return point and has been refilled;
wherein the control chip is first configured on a chip socket, the chip socket being further plugged onto the ink cartridge.
